(19) United States
(12) Patent Application Publication
(10) Pub. No.: US 2012/0224358 A1
(43) Pub. Date: Sep. 6, 2012

(54) PROGRAMMABLE LIGHTING DEVICE

(75) Inventors: Barry A. Noble, Darlington (GB); Fergus M. Noble, Darlington (GB); Robin Liang, Yangjiang (CN)

(73) Assignee: Nite Ize, Inc., Boulder, CO (US)

(21) Appl. No.: 13/346,692

(22) Filed: Jan. 9, 2012

Related U.S. Application Data
(63) Continuation-in-part of application No. 12/102,402, filed on Apr. 14, 2008.
Application No. 12/102,402 is a continuation-in-part of application No. PCT/GB2006/003558, filed on Sep. 26, 2006.

(30) Foreign Application Priority Data
Oct. 14, 2005 (GB) 0520975.4

(51) Int. Cl. F21L 4/00; F21V 31/00

(52) U.S. Cl. 362/158

(57) ABSTRACT

A flashlight having a control unit with a push button for activating the flashlight. The control unit connects to a computer via an USB port, whereby user-configurable control information is downloaded. A computer program running on the computer enables operating conditions of the flashlight to be selected by a user according to predetermined types of activation, e.g., of the push button. The operating conditions are collated into operating instructions associated with the predetermined types of activation. The operating instructions are converted into byte code and downloaded to and stored on a memory in the control unit. Upon detecting a predetermined activation type, the control unit accesses the operating conditions and configures the flashlight accordingly.

### CROSS REFERENCE TO RELATED APPLICATIONS

This application is a continuation-in-part of U.S. patent application Ser. No. 12/102,402 filed on Apr. 14, 2008, which is a national stage application of PCT No. PCT/GB2006/003558 filed on Sep. 26, 2006, which claims priority to Great Britain Patent Application No. 0520975.4 filed on Oct. 14, 2005.

### BACKGROUND

The development and increased commercial use of LEDs in all kinds of lighting device has led to a desire to be able to control the power level and hence the brightness at which the devices operate. One reason for this is that modern LEDs can be exceptionally bright when run at full power. Such brightness may not be suitable for the task or mood for which the lighting device is needed, so it is useful to be able to select a more suitable brightness when required. Furthermore, when running at full power, LEDs can use substantial amounts of energy. Reducing the operating brightness also reduces the power consumption. This is especially useful when the lighting device battery-powered, as using reduced power can extend the life of the battery.

Handheld flashlights are a particular example of a lighting device where brightness control is used. One reason for this is the wide variety of situations or conditions in which one may use a flashlight. A known flashlight of this type is the EDC Ultimate Flashlight manufactured by HDS Systems, Inc. This flashlight permits the user to select the brightness of four levels which can be accessed quickly during use. The brightness of each level is selected from one of 19 or 20 preset (non-adjustable) levels. The user also can select from a number of preset flashing modes if they are desired instead of a steady beam. In this example, selection and setting is achieved by manipulating the flashlight's operating button. The flashlight is arranged to distinguish between short “clicks” and longer “presses” of the button, and the user is able to access and change the optional features described above by entering different sequences of clicks and/or presses. However, the limited vocabulary of sequences and their complexity makes the options on the flashlight difficult and time-consuming to set.

### SUMMARY

Embodiments of the flashlight system ameliorate the problems associated with known programmable lighting devices by providing a more user-friendly programming procedure. The flashlight system may provide more programming functionality, i.e., to increase the programming options and control available to the user.

At its most general, the flashlight system provides a lighting device programming system arranged to permit a user to program one or more operating configurations of a lighting device externally of the device, and to download the programmed operating configuration onto the lighting device, where they are then selectable by the user.

Programming the lighting device's configuration externally, i.e., remotely from the lighting device itself, gives greater flexibility and control to the user. One benefit may be the provision of greater control over the lighting device, i.e., the user may be able to set more features of the lighting device than was possible with previous devices.

Thus, in a first aspect, the flashlight system may provide a lighting system having: a lighting device for providing light, the lighting device having a light source, a power supply for providing electric current to the light source, a control unit for controlling operation of the lighting device, and a programming device remote from the lighting device and communicable with the control unit, the programming device having a computer program loaded thereon that is arranged: to receive commands from a user; to create one or more operation instructions on the basis of the received commands; and to communicate the created operation instruction(s) to the control unit; wherein the control unit has a memory for storing the communicated operation instruction(s) and activation means for causing the control unit to execute a stored operation instruction, each operation instruction being arranged to configure one or more operating conditions for the lighting device. Thus, a user may be able to set a value for one or more operating conditions of the lighting device in the programming device. The computer program on the programming device preferably is arranged to collate the set value or values into an operating instruction for downloading onto the control unit memory.

The lighting device preferably is portable, e.g., a torch or table lamp. It may be a fixed installation, e.g., room lighting. The programming device may be any device with suitable processing power, but preferably is a computer, e.g., PC or laptop. Preferably, the programming device includes a recognized user input device, e.g., keyboard or mouse, to enable the user to set the operating conditions easily.

The communication between the control unit and programming device may have any form. In one arrangement, the control unit and programming device have USB ports and are linked by a wired connection. Other types of wired connection are possible, as is wireless communication, e.g., using infrared technology. The control unit and processing device may only be communicable during downloading. They may be separate isolated entities at other times. In this case, when the lighting device is e.g., a pocket torch (flashlight), it only needs to be communicable to the device during programming; after the operating instruction(s) are set, the lighting device may be used remotely from and out of contact with the device.

In a second aspect of the flashlight system, there may be provided a lighting device having: a light source; a power supply for providing electric current to the light source; and a control unit for controlling operating of the light device, the control unit being communicable with an external device in order to receive one or more operation instructions from the external device, wherein the control unit is arranged to store the received operation instruction(s) and to execute a stored operation instruction upon receipt of a user command, each operation instruction being arranged to configure operating conditions for the lighting device. The lighting device may be portable, e.g. a flashlight or the like.

Whilst the light source may include any type of light emitting means, e.g., filament or halogen bulbs, one or more light emitting diodes (LEDs) are preferred. LEDs generally produce less heat during use than other light sources of equivalent brightness. A plurality of LEDs of the same or different color may be used. A group of red, green, and blue LEDs may be used to provide a range of output colors. For example, the relative brightness of these LEDs may be variable to provide output color selectivity. The light source also preferably includes a reflector element, e.g., to focus the emitted light from the LED(s) or other light emitter into a beam. The light source may be a replaceable module, e.g., to allow a user to select light emitter type or reflector element size. Larger diameter reflector elements give more powerful light beams. Modular reflector units also allow reflectors with different beam characteristics to be included in the lighting device. Preferably, each reflector module allows the reflector to move along the axis of the device. This allows the light from the emitter to be focused, or to have its beam coherence varied.

Preferably, the electronics for controlling the operation of the device are installed separately from the light source module, e.g., in the control unit. This arrangement makes the construction of the light source simpler and may reduce the cost of manufacture.

Preferably, the control unit includes electronic circuitry for operating the device. The control unit preferably includes a communication interface for receiving the operating instructions from the external processing device. As explained above, the communication interface may be of any convenient type, wired or wireless. In the embodiment described below, a USB port and associated circuitry is provided. The communication interface may also be arranged to send information to the external processing device, e.g., about the status of the lighting device.

The control unit also preferably has processing means or firmware or the like installed therein, arranged to configure operation of the lighting device on the basis of operating instructions received from the external processing device. The control unit preferably has a memory for storing a plurality of operation instructions. The firmware is preferably arranged to select one or more of the operating instructions to configure the lighting device on the basis of commands received from the user. Preferably, the control unit includes activation means, e.g., one or more push buttons, switches, or the like, to enable the user to send commands to the control unit, i.e., commands that may be recognized and acted on by the firmware.

Preferably, the control unit is contained in a housing, e.g., a modular housing that comprises part of a body housing the lighting device. The outer surface of the control unit housing preferably is part of the outer surface of the lighting device body. Preferably, the activation means is provided at the outer surface for easy access by the user during use.

Preferably, the body of the device and/or the control unit housing includes a mounting connection for securely mounting the lighting device, e.g., to keep the light source at a fixed location. The mounting connection may include a tripod bush, e.g., when the lighting device is a flashlight, to enable the flashlight to be mounted stably on a tripod during use. Alternatively, the mounting connection may be used to fix the lighting device to a wall or ceiling fitting, e.g., when the lighting device is used as interior, e.g., domestic lighting. The mounting connection may include a dovetail groove.

The control unit itself may be a third aspect of the flashlight system, expressed as a control unit for controlling a light source in a lighting device, the control unit having: a communications interface for receiving one or more operation instructions from an external (remote) processing device; a memory for storing the received operation instruction(s); input means for receiving commands from a user; and processing means for executing a stored operation instruction upon receipt of a user command, wherein each operation instruction is arranged to configure operating conditions for the lighting device. The control unit preferably includes embedded software arranged to interpret the operation instruction(s) and, based on the interpreted operation instruction, to configure components of the lighting device. The configuration step is explained in further detail below.

The power supply for the lighting device may be any convenient means of providing electric current for powering the light emitter. Preferably, the power supply is arranged to supply DC current. For example, the power source may include an AC/DC converter, or may comprise a battery. Preferably, the power supply is portable, e.g., it may be contained in a modular housing. A modular system may also allow different types or sizes of batteries to be connected to the control unit or light source. The battery housing may be sized to fit different batteries. For example, a short battery housing may fit one battery to achieve compact size, whereas an alternative housing may fit two or more batteries to increase the working life of the device.

Preferably, the power supply is arranged to deliver a set current output over a range of input voltages. The output current is a measure of the brightness of the light emitter. Thus, the operation instruction may be arranged to set the current level provided to the light source, and the power supply, therefore, preferably is able to deliver that set current, whatever the voltage value of the connected power supply.

Preferably, the circuitry of the lighting device is arranged to operate within a working voltage of 1.6 or 1.8 to 24 V (volts) or more. This allows the device to be powered from a diverse range of power supplies including many types of battery, both rechargeable and non-rechargeable, the external device via a wired, e.g., USB connection, and a car battery, e.g., via a car adapter similar to those used for mobile telephones. As described above, the USB connection or car adapters similar to those used for mobile telephones may also be used for charging purposes of rechargeable batteries.

The lighting device may include one or more operating buttons in addition to the activation means on the control device. These additional operating button(s) may function independently of the control unit, but their operations preferably are configurable by the control unit and, therefore, preferably are programmable by the user at the external device. In the flashlight embodiment, the additional operating button(s) preferably include a tail switch located on the end of the flashlight body opposite the light source. The tail switch may perform a different function from the activation means on the control unit, which itself may be a simple switch. The tail switch may be a push button switch; the control unit may be able to distinguish between short and long presses on the switch. The distinction between short and long presses, e.g., the length of time the switch must be depressed to count as a long press, may be configure by the control unit, e.g., on the basis of an operation instruction. Thus, this distinction may be programmed by a user on the external device.

Alternatively or additionally, the tail switch can provide more sophisticated modes of operation than simple on/off behavior. Preferably, the tail switch is arranged to send a signal to the control unit so that the control unit can respond by adjusting the device's output according to a customizable operating instruction, as described below. One way to achieve this is to wire the tail switch directly into the control unit. However, arranging for the tail switch to be wired in this way can make the engineering of the connections between the tail switch control unit and power supply difficult. Preferably, the tail switch, therefore, is arranged to momentarily disconnect the power supply when actuated. The disconnection can be detected by the control unit. Thus, a sequence wherein the power supply is initially connected, then disconnected, and then reconnected within a set time period may be seen by the control unit as a tail switch “on” actuation. A second similar sequence may be recognized as a tail switch “off” actuation. Alternatively, the tail switch may perform a latching operation, where a disconnect-reconnect cycle occurs once for a complete “on” and “off” actuation cycle (e.g., push and release) of the tail switch.

In a development of this idea, the device may include other switches that are arranged to mimic the tail switch behavior. The device may have several such switches operating together so that any of them can trigger the tail switch behavior. For example, in a flashlight configuration, one might want to have a regular push button operating in tandem with a remote “tape” switch, commonly used on existing weapon mounted flashlights.

The control unit may store a flag which represents an operating instruction that indicates how the device should react to a tail switch actuation. This flag is checked upon power-up of the device and, if the flag is clear, the device continues normal operation; but if the flag is set, then the device performs the behavior for a tail switch actuation. This flag may be cleared initially, but before the device resumes normal operation, the flag is set so that a subsequent tail switch actuation will trigger the set behavior. The flag may be cleared before the tail button behavior is performed. The flag may be stored in memory whereby its state is preserved during power down.

In a most preferred embodiment, the tail switch push button has a locking facility to prevent accidental operation of the device. For example, the button may be twisted into a state that prevents pressing.

The additional operating button(s) may be provided on a separate module, so the user may choose the type or number of buttons on his device.

The modular nature of the lighting device may be a fourth aspect of the flashlight system. Thus, there may be provided a kit for constructing a lighting device, the kit including a plurality of modules interconnectable to form the lighting device, wherein the plurality of modules include: one or more interchangeable light source modules; one or more interchangeable power supply modules for providing electric current to the light source module; and one or more interchangeable control unit modules for controlling operation of the light source, each control unit module being communicable with an external device in order to receive one or more operation instructions from the external device, the control unit being arranged to store the received operation instruction(s) and to execute a stored operation upon receipt of a user command, each operation instruction being arranged to configure operating conditions for the light source, wherein the assembled lighting device includes at least one of a light source module, power supply module, and a control unit module.

Preferably, the kit includes one or more interchangeable switch modules, each having one or more operating buttons thereon, whose functions preferably are controlled by the control unit. The modular system thus may enable the creation of lighting devices according to customer requirements. One advantage may be that each control unit module may be usable in a wide range of lighting devices whose purposes are different. The control unit may be versatile enough to be programmed in a way that is consistent with those purposes.

Turning now to the configuration of the lighting device as mentioned above, the control unit is arranged to access and interpret a stored operation instruction upon receipt of a command from the user in order to set one or more control parameters of the lighting device. A wide variety of configurable parameters may be provided. Alternatively, the operation instruction may be arranged to set only one or two parameters. In this case, certain characteristics of the lighting device will be preset and non-adjustable. Preferably, however, each operation instruction is arranged to configure the complete set up of the lighting device.

Thus, in use, a user selects values for the parameters that are configurable by an operation instruction on the programming device. The programming device preferably includes software to convert the user-selected values into an operating instruction that then can be downloaded onto the control unit of the lighting device.

Thus, in a fifth aspect of the flashlight system, there is provided a computer program product comprising a computer program for loading on a processing device that is communicable with a lighting device, the computer program being arranged to cause the processing device: to receive commands from a user of the processing device; to create one or more operation instructions on the basis of the received commands; and to communicate the created operated instruction(s) to the lighting device, wherein each operation instruction is arranged to configure operating conditions (e.g., parameter values, etc.) for the lighting device. The operating conditions of the lighting device, therefore, may be set by the user by operating the computer program on the processing (programming) device.

The operating conditions that may be set by the user can include one or more or all of the following properties of the lighting device.

The brightness of the light source may be set by the value of one or more parameters in the operating instruction. The brightness typically is related to the electric current provided to the light source; the operating instruction may include a value representative of this current. The user may simply choose a value for the brightness, e.g., from a list of numbers ranging from low (for low brightness) to high (for high brightness). For example, the user may be able to select any number between 0 and 127. Alternatively, the user may be able to select a value representing the percentage of maximum brightness required. For example, the user would select 100% if maximum brightness was desired, or 50% if half brightness was required.

The operating instruction may configure the lighting device so that a sequence of differing configurations is provided. A sequence preferably includes two or more basic configuration blocks, each configuration block containing value for one or more parameters used to configure the lighting device. Thus, an operating instruction may configure the lighting device to produce two or more consecutive output blocks, each having, e.g., a different brightness level. Preferably, the duration of each output block is selectable by the user and defined in the operation instruction.

The operation instruction may include a fade block arranged to gradually increase or decrease the brightness level between the different output blocks defined above. The duration of the fade block may also be selectable by the user. Thus, the rate of brightness change may be user-selectable.

The user may be able to program the lighting device to flash on and off, e.g., by programming output blocks with zero brightness level in between output blocks with visible brightness levels. Since the duration of the output blocks may be user-selectable, the length of pause between flashes as well as the length of the flashes themselves can be user-selectable.

The computer program may also provide a strobe option, e.g., a configuration block for configuring the lighting device to produce a series of rapid flashes having the same brightness level. Preferably, the computer program is arranged to allow the user to select the repeat rate of the strobe as well as the duration and brightness level of the strobe configuration block.

The computer program may also be arranged to implement a repeat loop in the operation instruction. In other words, the operation instruction may be arranged to repeat a series of one or more consecutive configuration blocks (e.g., output blocks, fade blocks, or strobe blocks, etc.). Thus, a user may create a sequence of blocks and then cause those blocks to be repeated by programming a repeat loop into the operation instruction. Preferably, the number of repeats effected by the repeat loop may be selectable by the user on the computer program.

In a development of the strobe block, the computer program may be arranged to configure a block that outputs a message as a series of flashes in Morse code. The user may be able to select or program the message to be output. For example, the computer program may include a sub-program for translating typed text into Morse code in dots and dashes (i.e., short and long flashes of the light source in this case). Such translating sub-programs are already known. The Morse code block may be added as part of a sequence of other configuration blocks and may be included in a repeat loop.

Preferably, the computer program also is arranged to configure other options available to the user when operating the lighting device. For example, the computer program may be arranged to set the functions of the operating switches (activation means, tail switch, etc.) on the lighting device. As an example, in one embodiment, the operation instruction may be arranged to cause the lighting device to toggle to a specific constant brightness when the tail switch is pressed. This brightness level may be selectable by the user in the computer program. The operation instruction may be further arranged to cause the lighting device to return to whatever it was previously doing when the tail switch is pressed again. This means that the user can toggle between a particular, e.g., complicated sequence of output blocks and a constant brightness.

The computer program may also allow the user to customize the gamma correction curve of the lighting device. This may be achieved by loading a table of gamma correction values, e.g., directly from a file on the programming device into the operation instruction. Alternatively, the control unit may be arranged to set the gamma correction to a power law relationship (the usual standard for gamma correction) but with an index that is selectable by the user. Thus, the user may select a value for the index in the computer program, which may then generate a table of values corresponding to the power law. The table of values may then be downloaded on the control unit to be used for gamma correction.

Preferably, the computer program product provides a graphical user interface on the programming device to provide a visual implementation of the operation instruction and programming procedure. Preferably, the block sequences referred to above can be constructed graphically, e.g., by “dragging and dropping” icons representing the different types of available blocks and separately selecting parameters associated with those icons. Alternatively or additionally, these sequences may be programmable directly in code.

After the sequences have been selected by a user of the computer program, the computer program is arranged to create an operation instruction out of the selected value. Preferably, the operation instruction contains a table of values representing parameters set by firmware in the control unit together with a portion of byte code representing the sequence or sequences defined by the user. Thus, the computer program is arranged to compile the user sequences directly into byte code for the control unit. By compiling the byte code for downloading the operation instruction into the control unit, the amount of memory space required in the control unit can be saved. Furthermore, because the control unit reads the sequences in byte code, the running speed of the device is increased.

In one embodiment, a flashlight includes a battery and a light-emitting system powered by the battery. The flashlight further includes a first body piece having an inner threaded portion. The flashlight further includes a second body piece having an outer threaded portion, the inner threaded portion configured to interlock with the outer threaded portion, the first and second body forming a cavity housing the battery and the light-emitting system, the light-emitting system including a charging port, the charging port sealed inside the cavity, the charging port configured to be revealed by unscrewing the first body in relation to the second body. Optionally, the charging port is accessible through an aperture in the second body when the first body and the second body are in a first position and the charging port is not accessible when the first body and the second body are in a second position. In one configuration, the second position provides a water-resistant seal to the charging port. In another configuration, the outer threaded portion is at a first end of the second body, a recessed portion adjacent to the outer threaded portion and distal from the first end of the second body in comparison to the outer threaded portion, the recessed portion including the aperture. Optionally, the inner threaded portion is distal from a first end of the first body in comparison to a sealing edge that is at the first end of the first body and adjacent to the sealing edge. In one option, the first end of the first body interfaces with the first end of the second body. In another option, the sealing edge covers the recessed portion in the second position. Optionally, the charging port is a USB port. Optionally, the outer threaded portion is adjacent to a first stop portion and distal to the first end of the second body in comparison to the first stop portion and the inner threaded portion is adjacent to a second stop portion, the second stop portion distal from the first end of the first body in comparison to the inner threaded portion, such that the first and second stop portion prevent the release of the first body from the second body.

In another embodiment, a flashlight includes a battery and a light-emitting system powered by the battery. The flashlight further includes a first body piece having an inner threaded portion. The flashlight further includes a second body piece having an outer threaded portion, the inner threaded portion configured to interlock with the outer threaded portion, the first and second body forming a cavity housing the battery and the light-emitting system, the light-emitting system including a USB port, the USB port sealed inside the cavity, and the USB port configured to be revealed by unscrewing the first body in relation to the second body.

In another embodiment, a flashlight includes a battery and a light-emitting system powered by the battery. The flashlight further includes a first body piece having an inner threaded portion. The flashlight further includes a second body piece having an outer threaded portion, the inner threaded portion configured to interlock with the outer threaded portion, the first and second body forming a cavity housing the battery and the light-emitting system, the light-emitting system including a USB port, the first and second body having a first position and a second position, the first position characterized by the USB port being accessible, and the second position characterized by the USB port being sealed within the cavity. Optionally, the charging port is accessible through an aperture in the second body when the first body and the second body are in the first position, and the aperture is in a side wall of the second body. In one alternative, the outer threaded portion is at a first end of the second body, a recessed portion adjacent to the outer threaded portion and distal from the first end of the second body in comparison to the outer threaded portion, the recessed portion including the aperture. In another alternative, the threaded portion is distal from a first end of the first body in comparison to a sealing edge that is at the first end of the first body and adjacent to the sealing edge. Optionally, the first end of the first body interfaces with the first end of the second body. Alternatively, the sealing edge covers the recessed portion in the second position.

### BRIEF DESCRIPTION OF THE DRAWINGS

An example of the flashlight system will now be described in detail with reference to the accompanying drawings in which:

FIG. 1 shows an exploded view of a lighting device (flashlight) which is an embodiment of the flashlight system;

FIG. 2 shows a transverse cross-sectional view of the flashlight shown in FIG. 1;

FIGS. 3a and 3b show two perspective views of the control unit of the flashlight shown in FIG. 1;

FIG. 4 shows the main menu screen of a graphical user interface created by a computer program product that is another embodiment of the flashlight system;

FIG. 5 shows a screen for setting the maximum LED current in the graphical user interface illustrated in FIG. 4;

FIG. 6 shows a screen for creating sequences of light outputs in the graphical user interface illustrated in FIG. 4;

FIG. 7 shows a screen allowing the graphical “drag and drop” creation of sequences;

FIG. 8 shows a graphically represented sequence;

FIG. 9 shows a screen of a graphical user interface that allows the user to alter the gamma correction curve for a lighting device;

FIG. 10 shows another embodiment of a flashlight; and

FIG. 11 shows a section of the flashlight of FIG. 10.

### DETAILED DESCRIPTION

### Further Options and Preferences

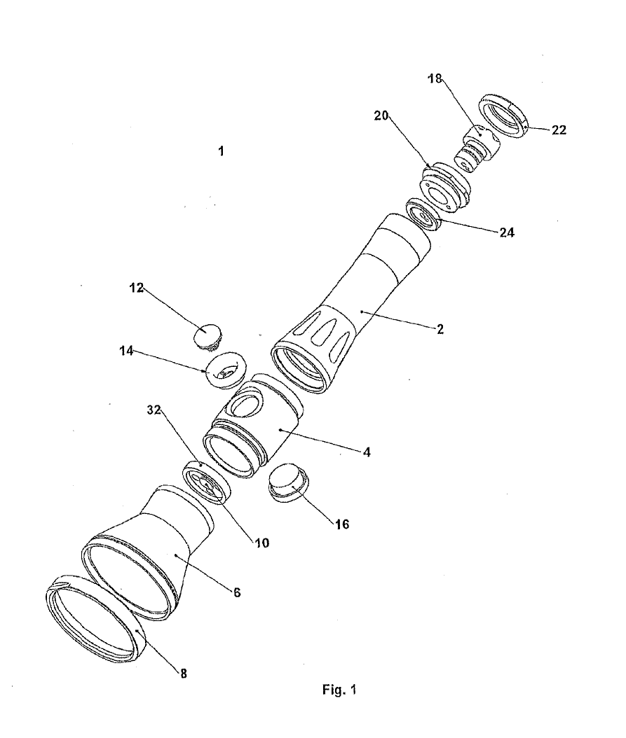

FIG. 1 illustrates the flashlight 1 that is a lighting device according to an embodiment of the flashlight system. The flashlight 1 has a battery body made of, e.g., aluminum for holding a battery which is the power force of the flashlight 1. At one end of the battery body 2, a control unit 4 is attached, e.g., by screw fittings, between the battery body 2 and a reflector 6. An LED is mounted on a light source module which attaches to the end of the control unit 4 facing the reflector 6. A transparent lens cover is attached to the front face of the reflector 6 by a lens ring 8.

To operate the control unit 4, a push button 12 is provided in its outer surface, secured by a button collar 14. A tripod bush 16 is built into the control unit 4 to enable the flashlight 1 to be stably mounted, e.g., remotely from a user or an another device, e.g., tripod, firearm, etc.

An additional means of operating the flashlight 1 is provided at the far end of the battery housing 2. A tail switch is provided in the form of a push button 18 which is mounted on the battery body 2 via a locking ring 22. The push button 18 acts through a tail bush 20 onto a spring disk 24. The tail bush 20 is arranged to detect when the push button is pressed in a conventional way.

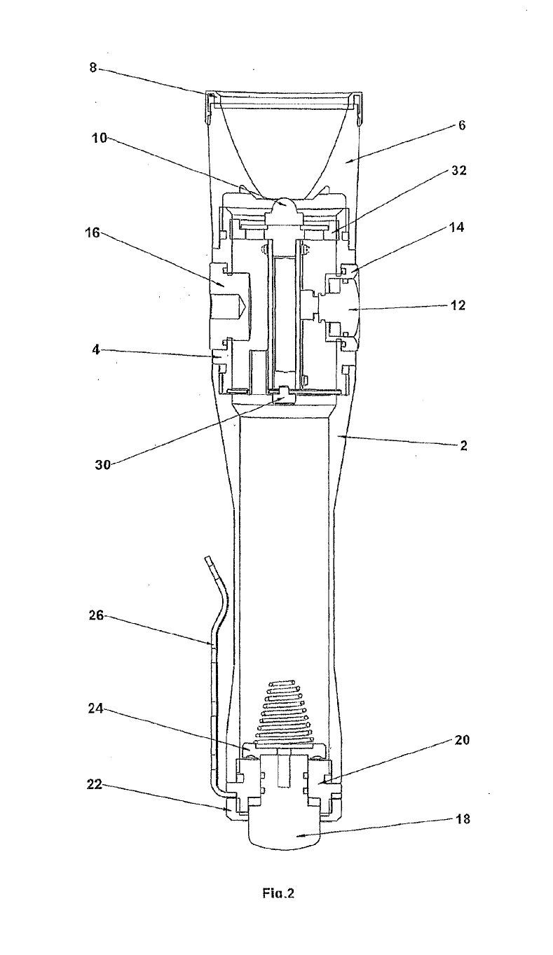

FIG. 2 shows a cross sectional view of the flashlight 1 when assembled. Features in common with FIG. 1 have the same reference numbers and are not described again. FIG. 2 shows that the battery body 2 also includes a bolt clip 26.

The flashlight shown in FIGS. 1 and 2 is formed from a number of modular components, which may be interchanged according to a user's requirements. The basic building block is the control unit 4, which is arranged to configure the remaining modules. The programming and functions of the control unit 4 are discussed in detail below. Around the control unit 4, various interchangeable reflectors 6, battery housings 2, light sources 10, and switch units 18 can be assembled.

For example, reflector units with different beam characteristics can be attached to the control unit. Each reflector unit includes the reflector 9 itself, with means for attaching it to the control unit 4, together with the lens and lens ring. In one type of module, the reflector 9 is slidable along the axis of the flashlight as is conventional, e.g., to focus the light from the light source or to vary the light beam coherence. This allows the reflector unit to be “tuned: to different types of light source.

The light source 10 itself is a separate module, which allows it to be replaced easily by the user in the event of a failure or upgrade. Different light emitters can be provided on different light source modules, e.g., LEDs, filament bulbs, etc. The modular structure allows any light source that can be powered from a constant current of below 1200 mA to be used in a light source module. Thus, a range of modules using LEDs of different power ratings can be provided, which could be bought separately and installed by the end user as optional upgrade(s).

The battery body 2 is another interchangeable module. Different sized battery housings may be provided, e.g., to fit different battery sizes.

The tail switch 18 can be changed to allow other switching options, e.g., remote control. The tail switch button 18 includes a physical battery disconnect switch to allow the user to “lock out” the controls to prevent accidental turn on. This is achieved by provided a quarter turn locking mechanism, whereby turning the tail switch button 18 through 90° prevents it from being pressed.

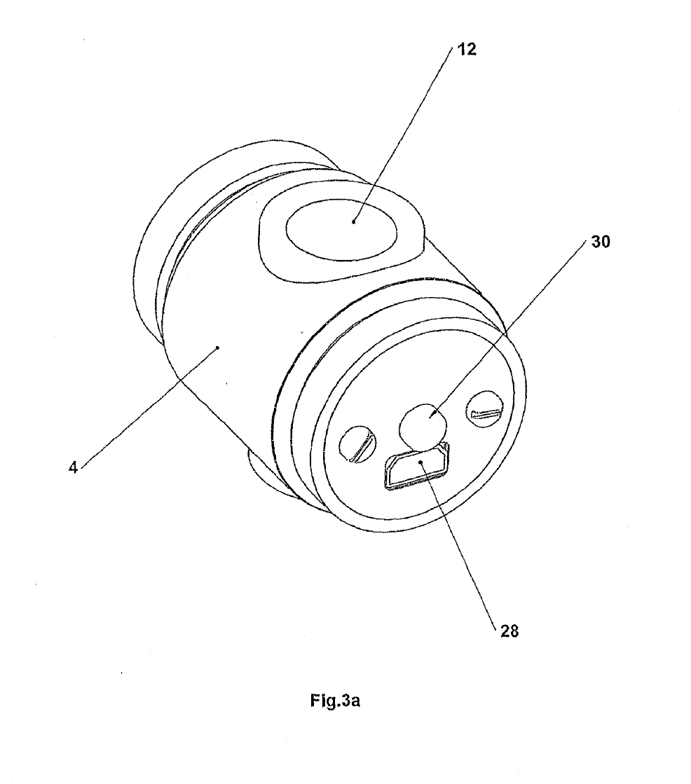

FIGS. 3a and 3b show the control unit 4 in more detail. FIG. 3a shows the end of the control unit 4 facing the battery housing. This end includes an electric contact 30 for contacting a battery terminal and a USB port for connecting the control unit 4 to a computer in order to download control information for the flashlight. This is described in more detail below. FIG. 3b shows the other end of the control unit 4, which has the light source module 32 (incorporating the LED 10) attached to it.

The control unit 4 is the main module of the flashlight 1. It includes a microcontroller for operating the device, and contains all of the electronic circuitry required by the device. There are three sections to the circuit. The first is the circuitry associated with the USB port 28. As shown, this USB port 28 may be accessed by unscrewing the body of the flashlight as shown in FIG. 3b. The ability to protect the USB port from potential damage in such a configuration provides for enhanced usage of the flashlight, since this provides for more easy waterproofing and protection against contaminates that might compromise the charging, powering, and programming of the flashlight. This provides a means by which the microcontroller and the computer for programming the device can communicate. The second section is the microcontroller and its support circuitry. The third section is the power supply for the light source module 32. This is controlled continuously by a DAC in the microcontroller. The power supply uses a boost converter topology with the load between the output and the positive supply rail, allowing the load to be supplied with anything from 0V to well over the supply voltage. A current sense resistor is employed with an amplifier and feedback loop to provide a constant current output that can be varied continuously between 0 and 1200 mA. The circuit protects against output short circuit by being current limited to 1200 mA. The circuit also is protected from the usual problem of high output voltages being produced in the event of an open circuit, associated with a constant current power supply. This is achieved by limiting the maximum output voltage.

The control unit 4 is arranged to maintain a set current output from the power supply irrespective of the power supply's (batteries) actual input voltage. This allows the device to be powered from a diverse variety of power sources including many different types of battery, both rechargeable and non-rechargeable, the USB interface, and a car adaptor. In the case of the device being powered by rechargeable batteries, these batteries may be charged through the USB interface.

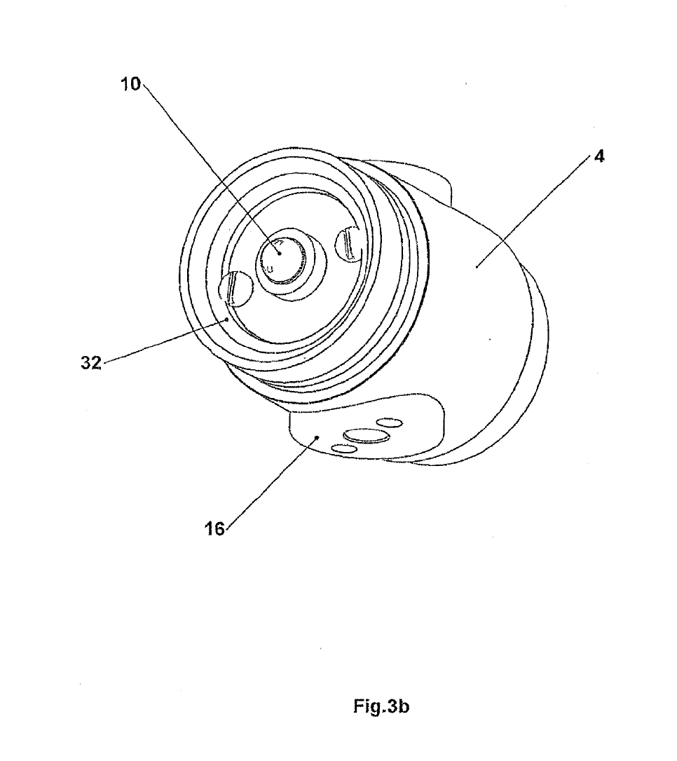

FIGS. 4 to 9 illustrate the graphical user interface (GUI) provided by a computer program product according to another embodiment of the flashlight system which permits the user to program the configuration of the control unit 4 and, hence, the flashlight 1. The USB interface described above provides a physical medium over which communications between the computer and control unit 4 takes place. The programming itself is enabled by embedded software present on the device, which interprets and implements operation instructions created on and downloaded from the computer using the GUI.

FIG. 4 shows the main menu screen 40 provided when the computer program is started. The main menu screen 40 presents a number of options to the user. There are three drop-down lists in the middle of the window, which configure the main behavioral options of the flashlight 1. The first drop-down list 42 enables the user to select the action caused by pressing and releasing the push button 12 on the control unit 4. The second drop-down list 44 enables the user to select the action caused by holding down the push button 12. The user may set the length of time the push button must be held down to qualify as a “hold” rather than a “press and release” through an item in the “Options” menu. The third drop-down list 46 enables the user to select the action caused pressing the tail switch button 18. In the embodiment shown, the tail switch 18 has a toggle effect, in that it switches the flashlight from whatever it is doing (e.g., off, flashing, etc.) to the brightness selected in list 46 when the tail switch button 18 is pressed and then back again when the button 18 is pressed again. Menu 46 offers the following options: Full, Half, Low, Off, and Custom, where the user is able to select brightness either as a percentage value of the full brightness level, or by using a number between 0 (off) and 127 (full brightness).

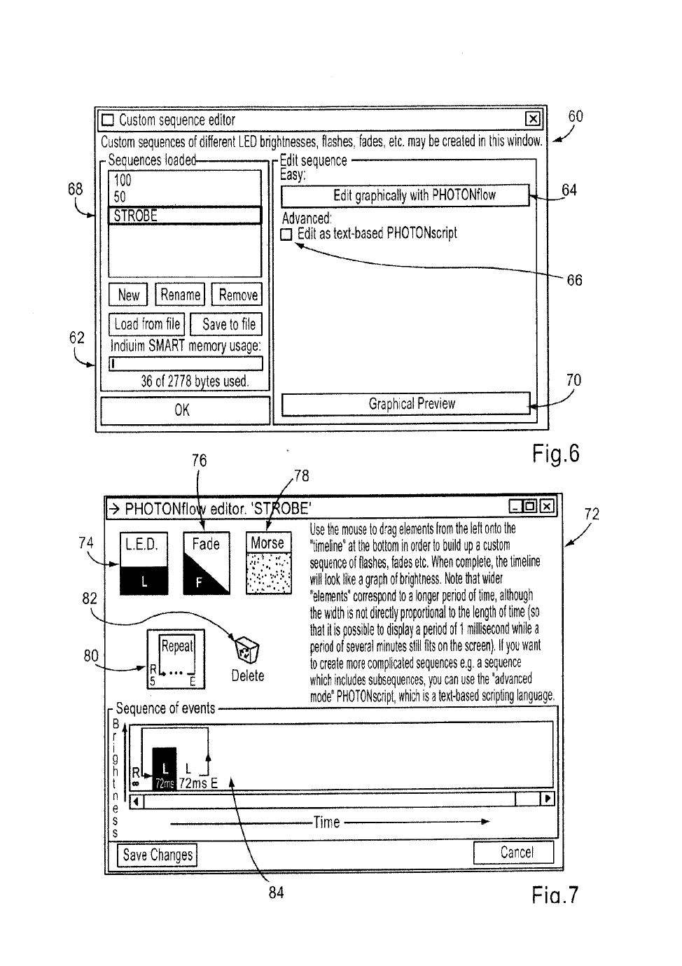

The first menu 42, which determines the behavior of the device when the control unit's button 12 is pressed and released, offers the following options: Turn the device on or off, or cycle through user sequences. Thus, the user can select between having the device simply turn on or off to a specific brightness level or having the device cycle through a particular subset of user-created sequences and turn off once the last sequence has been reached when the push button 12 is pressed and released. The button 48 to the right of the drop-down list enables the user to select more detailed options for the selected behavior. As shown in FIG. 1, the button 48 permits the user to select the brightness level to which the device switches. As before, the user is able to select brightness either as a percentage value of the full brightness level, or by using a number between 0 (off) and 127 (full brightness). The “cycle through user sequences” option makes use of the user-customized lighting sequences described in detail below. In this context, a “sequence” is a particular arrangement of the basic configuration blocks for the flashlight, e.g., the output level, pausing, fading between two output levels or repeated blocks. An example of a very basic sequence is setting the output (brightness) level at 75%, then pausing (zero output) for 5 seconds, and then repeating from the start. A more advanced sequence could consist of a fade up to 100% over 2 seconds, then three 0.2 second long flashes of 50% brightness with a 0.5 second delay in between, and then a fade from 100% down to 0% over 1 second. The computer program product allows the user to program such sequences and save them as files on the computer. One or more of these created sequences can be chosen when the “cycle through user sequences” option is selected, so that when the push button 12 on the control unit 4 is pressed, the flashlight 1 is configured to produce light output according to the sequences in that chosen order. The button 52 on the main menu screen 40 allows the user to go to the custom sequence editor screen (shown in FIG. 6).

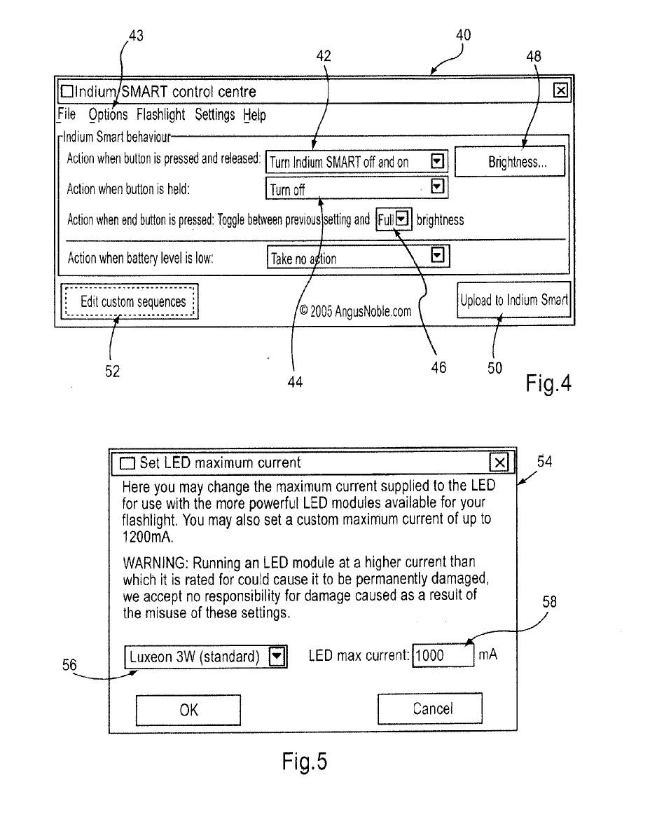

The “Options” menu item 43 also enables the user set the maximum current that the control unit 4 will permit to be supplied to the light source 10. FIG. 5 shows a screen 54 for setting the maximum current. The current level may be selected by choosing a light emitter type (e.g., a LED type) from the drop-down list 56, in which case the manufacturer's recommended maximum current may automatically be displayed in the current value box 58. Alternatively, the user may customize the flashlight 1 by entering his own chosen value directly into box 58.

The second menu 44, which determines the behavior of the device when the control unit's button 12 is held down, offers the following options: Turn off, Jump to certain user sequence, Fade to chosen brightness, Temporarily change to chosen brightness, and Temporarily change to chosen sequence. The user is prompted to choose a brightness or sequence for the latter two options. Thus, when the push button 12 is held, the flashlight may turn off, permanently jump to a certain user sequence, fade up and down between full and zero brightness until the button is released where it will maintain the level of brightness at which the button was released, temporarily change to a certain (customizable) brightness level while the button is held, or temporarily change to a certain user sequence while the button is held. A subsequent button press will return the device to the sequence it was running prior to the button hold. This last behavior allows the end user to quickly access a brightness level that they have not explicitly chosen as part of a sequence. The temporary options mean that the control unit 4 will be arranged to revert to whatever its previous behavior was when the push button 12 is released from holding.

Finally, the main menu screen 40 includes an upload button 50 which causes the computer program to download the selected information to the control unit 4 via an USB connection between the control unit 4 and the computer.

Turning to FIG. 6, sequences can be created by the user in two ways using the computer program. The first is to use the graphical sequence editor shown in FIG. 7. The second is to enter commands directly in a text-based scripting language. Both ways support the automatic generation of Morse code from text strings (see below).

FIG. 6 shows the basic sequence editor screen 60 which can be accessed by pressing the edit sequence button 52 on the main menu screen 40. The graphical editor screen (shown in FIG. 7) is accessed by selecting button 64, whereas the text-based editor screen is accessed by selecting box 66. Each sequence created by the user is given a name (defined by the user), which appears in the list 68 when the sequence is saved. The user chooses from this list when he selects the “cycle through user sequences” option from drop-down list 42.

FIG. 7 shows the graphical editor screen 72. Here, a graph 84 of brightness (intensity) against time is presented. Icons 74, 76, 78, 80 representing the various configuration options available to the user may be “dragged and dropped” into the graph 84 to create the different elements of the sequence. Their position in and length along the time line represents when and for how long in the sequence they occur. Their output brightness levels are represented by the vertical height of an intensity indicator on the block. The blocks then can be dragged to rearrange their order or dropped on the rubbish bin 82 to delete them. When a block in the sequence is selected, its parameters (brightness, duration, etc.) appear in the top right corner of the graphical editor screen 72, where they can be altered by the user.

In detail, icon 74 represents the LED output properties. The user may select the brightness and duration of the output. Icon 76 represents a fade (brightening or dimming of the LED). The user may select starting brightness, ending brightness, and fade duration. A computer simulated preview of the fade is given. Icon 78 programs in a sequence of short and long flashes representing a text string (entered by the user) in Morse code. Icon 80 is a repeat loop. The icon has two parts, the start icon (R) and end icon (E). The user can insert one or more other icons (including sub-repeats) in between the start and end icons. The inserted sequence icons then are repeated. The number of repeats may be selected by the user.

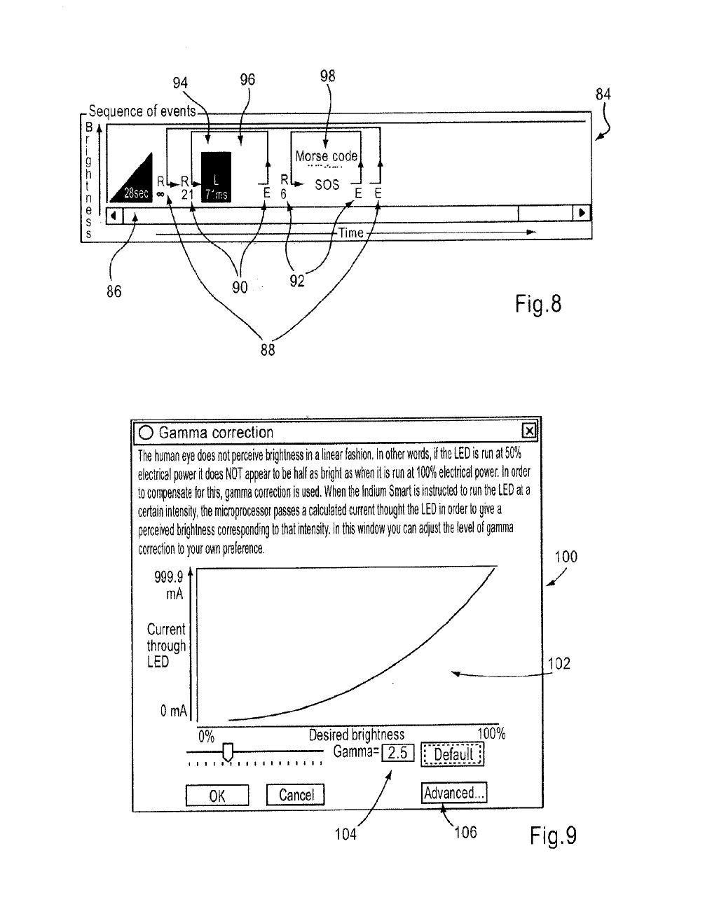

FIG. 8 shows an example of a sequence created using the graphical editor. The graph 84 shows the sequence begins with a fade block 86 which brightens the light from zero to full output in just over 2 seconds. This is followed by a repeat loop 88 which repeats endlessly two sub-repeat loops 90, 92. The first sub-repeat loop 90 is effectively a strobe, where a flash 94 of the light at full output for 72 ms followed by a pause 96 (zero output) for 71 ms is repeated 21 times. The second sub-repeat loop 92 repeats a Morse code output block 98 indicating SOS 6 times.

Alternatively, the user may enter the sequence in a text-based language which allows for greater control over the exact code sent to the device.

After a sequence is entered by either of the above methods, a graphical preview can be generated on-screen by the computer program by selecting preview button 70. The preview demonstrates what the sequence will look like when it is run on the device. If the device is currently plugged into the computer at the time, the user will also have the option to preview the sequence on the device itself, although this preview is run at a scaled down brightness (because the driving power is provided through the USB port).

Another feature provided by the computer program is the ability to customize the gamma correction curve. FIG. 9 shows a gamma correction screen 100 accessible from the “Options” menu 43 on the main menu screen 40. There are two ways in which the gamma correction curve can be customized. An advanced method (accessible via button 106), which offers the most flexibility, allows the user to load a table of gamma correction values directly from a file. More simply, the software allows the user to set the gamma correction to a power law relationship (as is standard for gamma correction) by setting a value for the index in box 104. This allows the end user to easily tweak the gamma correction relationship. There is an on-screen preview 102 of the relationship in the form of a graph of output power against perceived intensity.

When the user is happy with the choices made in the computer program, they can select the upload button 50 on the main menu screen 40. The software then will search for connected device(s) and, if one is found, the computer program will assemble all of the chosen options into a table of values which is used by the firmware (embedded software in the control unit 4). The user sequences are compiled directly into byte code for the microcontroller in the control unit 4. This technique saves memory space and increases running speed. The table of values and the sequence byte code then is concatenated to the firmware code which is stored in a separate file in the software distribution in byte code form. This code then is downloaded onto the microcontroller by a bootloader, resident in the microcontroller itself, e.g., in Intel HEX16 format. The interface between the bootloader on the chip and the computer is a simple ASCII serial protocol. This allows the firmware to be updated to a newer version simply by having the user download a new firmware file, e.g., from the Internet.

The embedded software in the control unit 4 is essentially divided into two independent components: the bootloader and the firmware. The bootloader usually is unchangeable and allows the computer to download new firmware to the microcontroller and perform a few other interfacing operations between the computer and device. On the other hand, the firmware can be changed and updated at any time by the bootloader and computer program. The firmware contains the code which implements the functions whose parameters are defined by the sequences. The sequences, therefore, represent one or more configuration blocks whose values, interpreted by the firmware, are used to control the device when it is not connected to the computer, i.e., it implements all of the options and button actions, etc.

The bootloader is the first code to run on the microcontroller and first checks if it is connected to an external device, e.g., a computer. If no external device is detected, then the bootloader attempts to transfer control to the firmware. If there is no valid firmware in memory, then it simply halts execution. If the device is connected to an external device, then the bootloader will enter a loop waiting for the computer to issue it a command. The computer can issue commands to transfer over the firmware, sequence, and option table data and write it to the internal memory or commands which call functions from the firmware (if present and valid) to set the output and all of the other functions used in a sequence. This is used for previewing the sequences on the device from the computer.

The firmware has two main functions: the first is to implement all of the functions needed by the sequences, e.g., setting the raw value of the output power, setting the output power with gamma correction, pausing for a certain length of time and fading between two brightness level at a variable speed; and the second function is to take control from the bootloader if the device is not connected to the PC and provide the user interface for the flashlight, i.e., responding to button presses and holds with the user-selected actions, running sequences, and interfacing to the power supply circuitry.

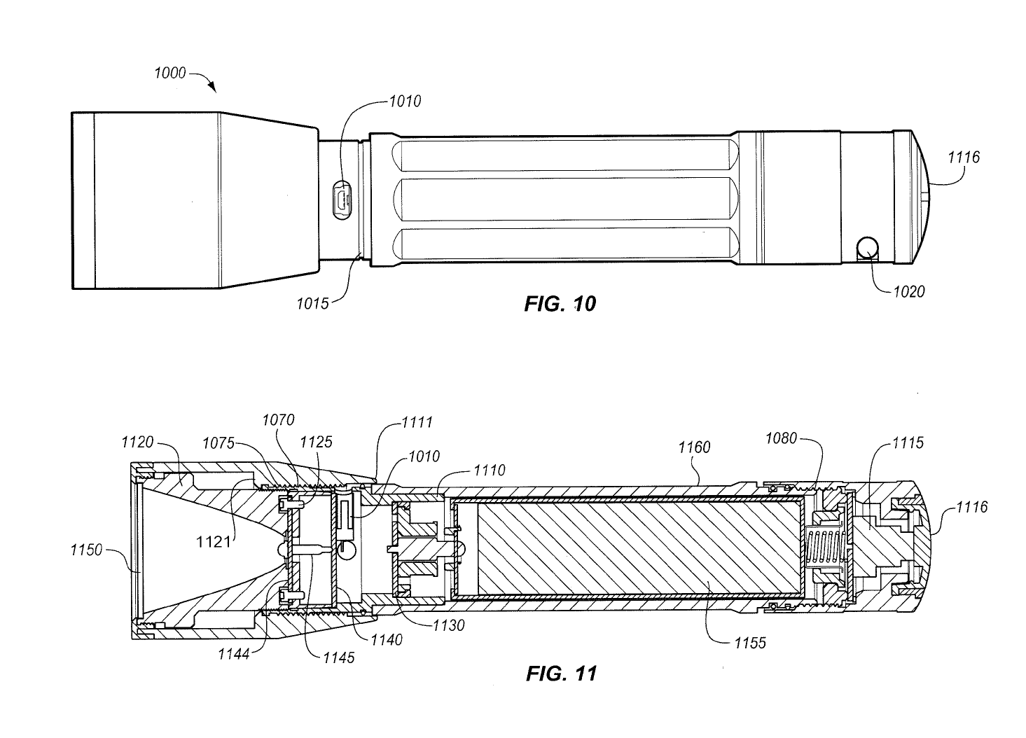

FIG. 10 shows another embodiment of the flashlight system. In this embodiment, the USB port is similarly enclosed within the device and protected from outside forces such as water or other contaminates. Flashlight 1000 includes an O-Ring slot shell 1015 that may be rotated to reveal the USB port 1010. FIG. 11 shows a cut-away view of the flashlight system. Here, USB port 1010 is visible. Optionally, this may be a mini USB port. O-Ring seal 1015 may engage the shell of the flashlight 1000 for a seal. O-Ring seal shell 1015 may in some embodiments include water proofing in the form of O-Rings around the closure such that a substantially water resistant seal is formed. Further visible is on/off switch 1020 on cap 1116. Cap 1116 may be twisted during activation of flashlight 1000 in order to activate different modes. The user may tighten the cap fully for a full on position of the light. For low mode, the user may tighten, loosen, and then tighten again. For momentary mode, the user may execute a half turn and hold on/off. These are merely examples of possible on/off configurations.

FIG. 11 shows a cutaway view of the flashlight 1000. Sealing piece 1110 and upper body shell 1111 are visible. These pieces interlock to engage in a watertight position. Lens 1150 is adjustable to provide focus according to its own threaded screw system. The light includes screw stops 1120, 1121 which prevent over rotation of the top portion and release of the top portion from the bottom. As screw tops 1120, 1121 are screwed towards each other, they will collide, preventing the further turning of the top and body piece in relation to each other. LED board 1144 and is held with screws 1125. LED connector 1145 engages with board 1140. Board 1130 may include power regulation circuitry and program circuitry to sense the turns of cap 1020. On/off button 1020 is also visible. This may be a monetary switch in some embodiments. Battery 1155 is housed within main body 1160. Interior and exterior threading portions 1070, 1075 interact to provide for access to the USB 1010. Threaded portion 1080 provides for the ability to twist the cap to actuate the flashlight's various modes as described above. This also provides for release of the battery.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein, but is intended to cover modifications within the spirit and scope thereof as defined by the appended claims and any and all equivalents thereof. Note that, although particular embodiments are shown, features of each attachment may be interchanged between embodiments.

We claim:

1. A flashlight, comprising:
a battery;
a light-emitting system powered by the battery;
a first body piece having an inner threaded portion; and
a second body piece having an outer threaded portion, the inner threaded portion configured to interlock with the outer threaded portion, the first and second body forming a cavity housing the battery and the light-emitting system, the light-emitting system including a charging port, the charging port sealed inside the cavity, and the charging port configured to be revealed by unscrewing the first body in relation to the second body.

2. The flashlight of claim 1 wherein the charging port is accessible through an aperture in the second body when the first body and the second body are in a first position and the charging port is not accessible when the first body and the second body are in a second portion.

3. The flashlight of claim 2 wherein the second position is provides a water resistant seal to the charging port.

4. The flashlight of claim 2 wherein the outer threaded portion is at a first end of the second body, a recessed portion adjacent to the outer threaded portion and distal from the first end of the second body in comparison to the outer threaded portion, the recessed portion including the aperture.

5. The flashlight of claim 4 wherein the inner threaded portion is distal from a first end of the first body in comparison to a sealing edge that is at the first end of the first body and adjacent to the sealing edge.

6. The flashlight of claim 5 wherein the first end of the first body interfaces with the first end of the second body.

7. The flashlight of claim 6 wherein the sealing edge covers the recessed portion in the second position.

8. The flashlight of claim 7 wherein the outer threaded portion is adjacent to a first stop portion and distal to the first end of the second body in comparison to the first stop portion and the inner threaded portion is adjacent to a second stop portion, the second stop portion distal from the first end of the first body in comparison to the inner threaded portion, such that the first and second stop portion prevent the release of the first body from the second body.

9. The flashlight of claim 7 wherein the charging port is an USB port.

10. A flashlight, comprising:
a battery;
a light-emitting system powered by the battery;
a first body piece having an inner threaded portion; and
a second body piece having an outer threaded portion, the inner threaded portion configured to interlock with the outer threaded portion, the first and second body forming a cavity housing the battery and the light-emitting system, the light-emitting system including a USB port, the USB port sealed inside the cavity, and the USB port configured to be revealed by unscrewing the first body in relation to the second body.

11. A flashlight comprising:
a battery;
a light-emitting system powered by the battery;
a first body piece having an inner threaded portion; and
a second body piece having an outer threaded portion, the inner threaded portion configured to interlock with the outer threaded portion, the first and second body forming a cavity housing the battery and the light emitting system, the light emitting system including an USB port, the first and second body having a first position and a second position, the first position characterized by the USB port being accessible, and the second position characterized by the USB port being sealed within the cavity.

12. The flashlight of claim 11 wherein the charging port is accessible through an aperture in the second body when the first body and the second body are in the first position, and the aperture is in a side wall of the second body.

13. The flashlight of claim 12 wherein the outer threaded portion is at a first end of the second body, a recessed portion adjacent to the outer threaded portion and distal from the first end of the second body in comparison to the outer threaded portion, the recessed portion including the aperture.

14. The flashlight of claim 13 wherein the inner threaded portion is distal from a first end of the first body in comparison to a sealing edge that is at the first end of the first body and adjacent to the sealing edge.

15. The flashlight of claim 14 wherein the first end of the first body interfaces with the first end of the second body.

16. The flashlight of claim 15 wherein the sealing edge covers the recessed portion in the second position.

17. The flashlight of claim 16 wherein the outer threaded portion is adjacent to a first stop portion and distal to the first end of the second body in comparison to the first stop portion and the inner threaded portion is adjacent to a second stop portion, the second stop portion distal from the first end of the first body in comparison to the inner threaded portion, such that the first and second stop portion prevent the release of the first body from the second body.
